(19) United States
(12) Patent Application Publication
(10) Pub. No.: US 2015/0031002 A1
(43) Pub. Date: Jan. 29, 2015

(54) RECOMMENDING REESTABLISHMENT OF DISCONTINUED PRODUCTIVE HABITS

(71) Applicant: INTERNATIONAL BUSINESS MACHINES CORPORATION, ARMONK, NY (US)

(72) Inventors: Catalina M. Danis, Mount Vernon, NY (US); Robert G. Farrell, Cornwall, NY (US); Wendy A. Kellogg, Yorktown Heights, NY (US); Sreeram Ramakrishnan, Yorktown Heights, NY (US)

(73) Assignee: INTERNATIONAL BUSINESS MACHINES CORPORATION, ARMONK, NY (US)

(21) Appl. No.: 13/953,738

(22) Filed: Jul. 29, 2013

(51) Int. Cl. G09B 5/00

(52) U.S. Cl. CPC G09B 5/00
USPC 434/236

(57) ABSTRACT

A method, system and computer program for recommending reestablishment of discontinued productive habits. An example method includes recording behaviors over time in pursuit of an identified goal, measuring progress towards an identified goal over time, identifying one or more periods of time where positive progress toward the identified goal resulted, identifying one or more periods of time where negative progress toward an identified goal resulted, identifying, by an electronic computer processor, differences in the behaviors between the periods of time where the positive progress resulted and the periods of time where the negative progress resulted, and recommending behavior changes based on the identified differences of the behaviors.

### BACKGROUND

This invention relates to behavior analysis, and more particularly to a method and system of recommending reestablishment of unintentionally discontinued productive habits.

A healthy lifestyle can prevent or delay medical conditions, elevate mood, improve energy, stabilize sleep, and have other positive effects. People often lead a healthy lifestyle due to establishing good habits. However, over time these good habits may be discontinued, leading to backsliding. This is often unintentional; the good habits slip away and are forgotten.

Mobile phones, sensors, and other devices are making it increasingly possible to collect fine-grained behavioral data about individuals, often with little work on the part of the user. In addition, tools are increasingly becoming available that allow their users to track their food and/or exercise manually on a web site or smart phone. This tracking makes it possible for users to maintain a long-term fine-grained history of their lifestyle-related choices. This data can be used as input to computer systems for recommending healthy behaviors.

### BRIEF SUMMARY

Accordingly, one example of the present invention is a method for recommending reestablishment of discontinued productive habits. The method includes recording behaviors over time in pursuit of an identified goal. The method further includes measuring progress towards the identified goal over time. An identifying step identifies one or more periods of time where positive progress toward the identified goal resulted. The method further includes identifying one or more periods of time where negative progress toward the identified goal resulted. The differences in the behaviors between the periods of time where the positive progress resulted and the periods of time where the negative progress resulted are identified by an electronic computer processor. Additionally, the method further includes recommending behavior changes based on the identified differences of the behaviors.

Yet another example of the present invention is a system for recommending reestablishment of discontinued productive habits. The system includes a system memory and a computer processor coupled to the system memory. A recording unit is coupled to the computer processor. The recording unit records behaviors over time in pursuit of an identified goal. The system further includes a measuring unit to measure progress towards the identified goal over time. The system further includes an identifying unit to identify one or more periods of time where positive progress toward the identified goal resulted. The identifying unit identifies one or more periods of time where negative progress toward the identified goal resulted. The identifying unit also determines differences in the behaviors between the periods of time where the positive progress resulted and the periods of time where the negative progress resulted. The system further includes a recommending unit to recommend behavior changes based on the identified differences of the behaviors.

A further example embodiment of the present invention is a computer program product for recommending reestablishment of discontinued productive habits. The computer program product includes computer readable program code configured to: record behaviors over time in pursuit of an identified goal; measure progress towards the identified goal over time; identify one or more periods of time where positive progress toward the identified goal resulted; identify one or more periods of time where negative progress toward the identified goal resulted; identify, by an electronic computer processor, differences in the behaviors between the periods of time where the positive progress resulted and the periods of time where the negative progress resulted; and recommend behavior changes based on the identified differences of the behaviors.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a system for recommending reestablishment of discontinued productive habits according to one embodiment of the present invention.

FIG. 2 shows a method for recommending reestablishment of discontinued productive habits in accordance with one embodiment of the present invention.

### DETAILED DESCRIPTION

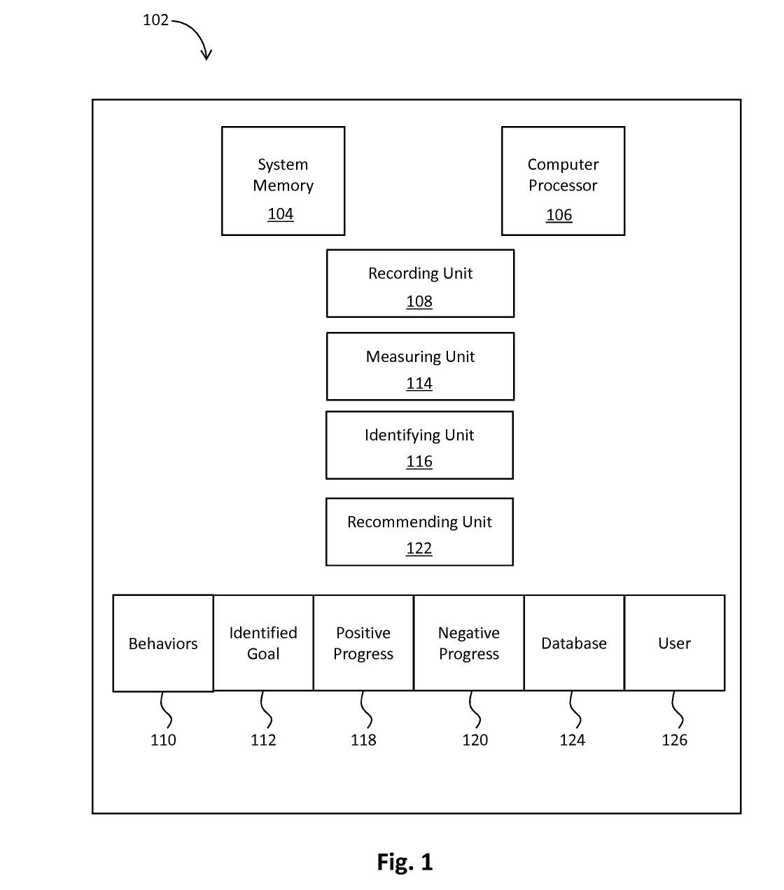

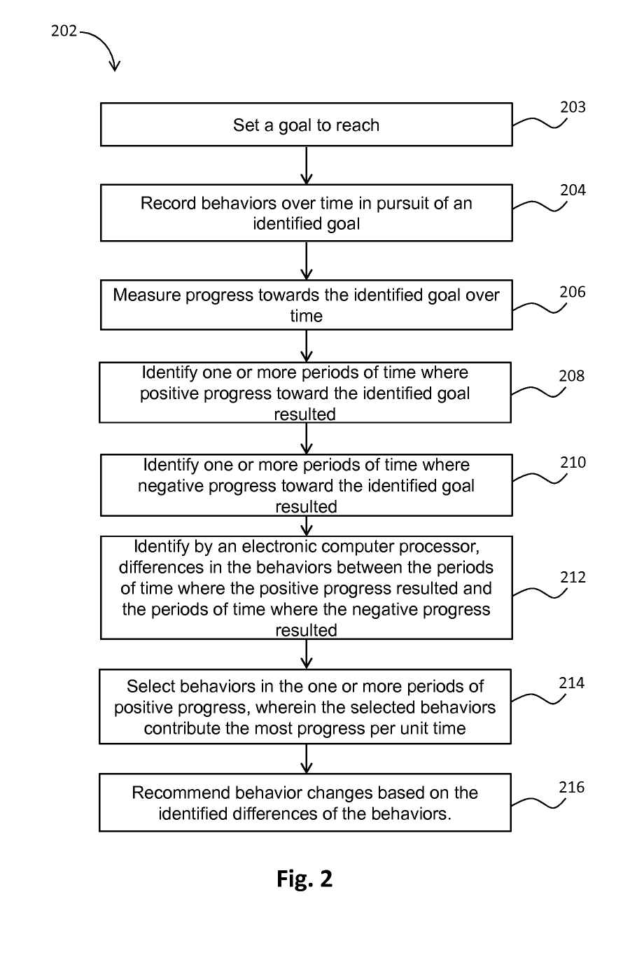

The present invention is described with reference to embodiments of the invention. Throughout the description of the invention reference is made to FIGS. 1-2. When referring to the figures, like structures and elements shown throughout are indicated with like reference numerals.

In one embodiment, recommending reestablishment of discontinued productive habits may use the Intrapersonal Retrospective Recommendation (IRR) system as a method for generating lifestyle change recommendations. This approach may use recommendations based on what behaviors worked and did not work for the individual in the past. Stable patterns of behavior within a prior time period may be more predictive of an individuals' future behavior than the common behavior patterns of other users. Hence, behavioral patterns in periods of success at lifestyle change or maintenance that is not being followed can be recommended when the user is facing a similar goal but not succeeding. Similarly, the system can recommend cessation of behavior patterns that are found in prior periods of failure at lifestyle change or maintenance as long as a similar goal is being pursued.

FIG. 1 shows a system 102 for recommending reestablishment of discontinued productive habits according to one embodiment of the present invention. The system may include a system memory 104, a computer processor 106, a recording unit 108, a measuring unit 114, an identifying unit 116, and a recommending unit 122.

The recording unit 108 is coupled to the computer processor 106. The recording unit 108 records behaviors 110 over time in pursuit of an identified goal 112. For example, users 126 may register and input their current weight and goal weight on a website. In one embodiment, the recording unit 108 may send a request to the user to update data that is useful in carrying out its recommendation task. For example, the recording unit 108 may notify the user that he or she is failing to enter weight or log food/exercise on a consistent basis.

The measuring unit 114 measures progress towards the identified goal 112 over time. At each unit of time, the system may mark the weight at a transition point (e.g., 12:01 AM on Monday of each week), compute repeated (2 or more) items (“habits”) for the month, sum the calories contributed by that habit during that month, and sort habits by the sum of their calorie contribution for that month. For example, drinking soda every day may contribute the most toward calories in a given month, followed by eating hamburgers, and so on.

The identifying unit 116 identifies one or more periods of time where positive progress 118 toward the identified goal 112 resulted. This may happen, for example, if average weight per week is decreasing. The identifying unit 116 further identifies one or more periods of time where negative progress 120 toward the identified goal 112 resulted. For example, if average weight per week was increasing.

Lack of positive progress can constitute negative progress. For example, if a user is losing weight at two pounds per week and then levels off to zero pounds per week, the zero pounds per week is negative progress. Furthermore, slower progress can constitute negative progress. For example, if a user is losing weight at two pounds per week and then starts losing at only one pound per week, this may be negative progress. The identifying unit 116 also identifies, by an electronic computer processor, differences in the behaviors and/or habits 110 between the periods of time where the positive progress 118 resulted and the periods of time where the negative progress 120 resulted.

The recommending unit 122 recommends behavior changes based on the identified differences of the behaviors and/or habits 110. Recommendations may not just be generated to start behaviors. They are also to, for example: a) decrease the frequency and/or portion size of high calorie foods; b) increase the frequency of low calorie foods; or c) increase the frequency, intensity, or time for exercise. These changes may be based on the net calories saved. For example, if the pattern of eating hamburgers started in period 4 and it contributes significantly to the net calories then recommend reducing the number and/or size of hamburgers.

The recommending unit 122 can account for instances where progress towards a goal becomes progressively more difficult as time passes. For example, weight loss is often easier at the beginning of a diet. In this situation, the recommending unit 122 can discount behaviors that occurred later in time. Thus, the recommending unit 122 can avoid making recommendations to go back to habits that worked when you were, say, 50 pounds heavier.

In one embodiment of the present invention, the behaviors may be patterns of choices over time. The patterns of choices may be selected from a group including food, activities, and products.

In one embodiment of the invention, the behaviors 110 may be recorded into a database 124 over a period of time, such as one week. In one embodiment of the invention, the measurement of progress may be performed by comparing a level of progress at the start of the period of time and a level of progress at the end of the period of a time.

In one embodiment of the invention, positive progress 118 may be behaviors that contribute toward the identified goal 112. Negative progress 120 may be behaviors that detract from the identified goal 112. The computer processor 106 may be configured to select behaviors 110 in the one or more periods of positive progress 118, wherein the selected behaviors contribute the most progress per unit time.

In one embodiment of the invention, the computer processor may be configured to select behaviors 110 in the one or more periods of positive progress 118 that are not found during the one or more periods of negative progress 120.

In one embodiment of the invention, the recommended behavior changes may be presented to a user 126. In other embodiment, system 102 can be used in other applications. For example, the lifestyle monitoring data may be used to justify discounts on health insurance.

FIG. 2 shows a method for recommending reestablishment of discontinued productive habits 202 in accordance with one embodiment of the present invention. The method includes a goal setting step 203 of setting a goal to reach. The goal might be a weight target or a target number of exercise steps, for example. The goal can come from the user, someone else (care plan from a health provider), or part of an automated process. The method includes recording step 204. During the recording step 204, behaviors are recorded over time in pursuit of an identified goal.

In one embodiment, recording step 204 may include sending a request to the user to update data that is useful in carrying out its recommendation task. For example, the system may notify the user that he or she is failing to enter weight or log food/exercise on a consistent basis. After recording step 204 is completed, the method continues to measuring step 206.

At measuring step 206, progress towards the identified goal is measured over time. After measuring step 206 is completed, the method continues to identifying step 208.

At identifying step 208, one or more periods of time where positive progress toward the identified goal resulted is identified. Identifying the periods of time where positive progress toward the identified goal resulted may include identifying behaviors that contribute toward the identified goal. After identifying step 208 is completed, the method continues to identifying step 210.

At identifying step 210, one or more periods of time where negative progress toward the identified goal resulted is identified. Identifying one or more periods of time where negative progress toward the identified goal resulted may include identifying behaviors that detract from the identified goal. As mentioned above, lack of positive progress or slower progress can constitute negative progress. After identifying step 210 is completed, the method continues to identifying step 212.

At identifying step 212, an electronic computer processor identifies differences in the behaviors between the periods of time where the positive progress resulted and the periods of time where the negative progress resulted.

In one embodiment, the method may find potential changes in stable patterns. These changes in stable patterns may be computed in three categories of changes across the “current period” and prior periods. The first category may be cessations which are patterns that existed but no longer appear in the current period (e.g., no more toast and skim milk at breakfast). For this the immediately prior period can be used. The second category may be formations which are patterns that emerged in the current period (e.g., chocolate croissant and bacon start appearing at breakfast). The third category may be substitutions which are patterns that existed but have been modified (e.g., toast has butter, a cup of skim milk instead of whole milk).

After identifying step 212 is completed, the method continues to selecting step 214. At selecting step 214, behaviors in the one or more periods of positive progress are selected. The behaviors that contribute the most progress per unit time toward the identified goal are selected. For example, drinking unsweetened ice tea repeatedly may result in a small number of calories per week and thus would be selected. After selecting step 214 is completed, the method continues to recommending step 216.

At recommending step 216, behavior changes based on the identified differences of the behaviors are recommended. One or more of the behaviors selected in step 212 are presented to the user. Information, help, or training associated with performing the behaviors may be presented along with the suggested behavior(s). The system may remind the user about the behavior. For example, it may associate with behavior with an event (e.g., just before Christmas, you were losing weight and drinking diet drinks).

In one embodiment, recommending step 216 can account for instances where progress towards a goal becomes progressively more difficult as time passes. For example, weight loss is often easier at the beginning of a diet. In this situation, recommending step 216 can discount behaviors that occurred later in time.

Recommending step 216 can account for instances where progress towards a goal becomes progressively more difficult as time passes. For example, weight loss is often easier at the beginning of a diet. In this situation, recommending step 216 can discount behaviors that occurred later in time.

Once the recommender system has access to this kind of long history of behaviors for a given user, then it is possible to identify periods where users were doing better than they are currently. How can these periods be found? Fortunately, instrumented networked devices, such as meters, scales, and so on, now allow individuals to track measurements such as weight, waist size, and number of calories above or below some target budget or level to determine progress against their goals over time.

In one embodiment, the method for recommending reestablishment of discontinued productive habits may use the fact that the user was more productive (e.g., at weight loss) during a given period as a signal to find old habits in those periods that were unintentionally discontinued and could be re-established. The algorithm evaluates how good the old habit is by looking at the contribution of the habit per unit time toward the overall level of progress during that period. In the weight loss domain, for example, we can find periods (e.g., months) where the user was losing more weight per unit time than in the recent past. We then find which things they ate repeatedly during those period; we call these ‘habits’ (though using something twice may not really constitute a habit). We then look at the relative contribution of all the habits to the successful weight loss (or maintenance) during that period. We then find those habits that the user has probably unintentionally discontinued and “forgotten”.

In another example embodiment, suppose Rachel is successfully maintaining her weight but wants to lose 20 pounds. Instead, she starts gaining weight. The recommender sees she had started eating two strips of bacon every day and started drinking tea twice a week as her weight started creeping up during that period. Our method would recommend that she reduce or stop eating bacon, not tea, because bacon (345 calories/week) was a larger contributor to her calories per week than the tea (0 calories per week).

In one embodiment, the algorithm for the Intrapersonal Retrospective Recommendation (IRR) system may include finding periods of success and failure, finding stable patterns, finding potential changes in stable patterns, determining if potential changes in stable patterns will contribute or detract from the goal, recommend changes with the largest impact, and identifying changes at a particular place and time. These steps are described below.

Find Periods of Success and Failure: Establish the individual's goals as a Boolean combination of measures to maintain, increase, or decrease (e.g., maintain weight while reducing fat intake by 10%). Calculate periods of consistent goal achievement (e.g., maintaining weight) or failure over time using historical data (e.g., weight 190 and fat intake of only 25 mg/day average). A period of one week may be used as a minimum length period since physical changes are difficult to measure in smaller periods.

Find Stable Patterns: Identify stable patterns as repeated items within each period contributing most and least to the goal (i.e., net calories). For example, eating a diet snack an average of four times per month while reducing fat intake or running on the treadmill 12 times a month while losing weight. Any item in the log more than once is used, but the top N=20 items are selected according to their contribution toward the goal (i.e., highest net calories).

Find Potential Changes in Stable Patterns: Compute three categories of changes across the “current period” and prior periods: Cessation—Patterns that existed but no longer appear in the current period (e.g., no more toast and skim milk at breakfast). For this we use the immediately prior period. Formation—Patterns that emerged in the current period (e.g., chocolate croissant and bacon start appearing at breakfast). Substitution—Patterns that existed but have been modified (e.g., toast has butter, a cup of skim milk instead of whole milk)

Determine If Potential Changes in Stable Patterns Will Contribute or Detract from Goals: Label stable patterns of change as contributing to or detracting from the user's goals. For example, toast and skim milk at breakfast add 180 calories but with only 5 mg of fat. On average, other breakfast choices of 180 calories have 10 mg of fat. Therefore, toast and skim milk would be labeled as contributing to the goal. For formation, the proportion of contribution to goals is used (e.g., chocolate croissant had a disproportionate contribution to both fat and calories.) For substitution, the difference can be evaluated as a formation (e.g., adding butter had a disproportionate contribution to fat). The results are ordered by net calories added or subtracted.

Recommend Changes With The Largest Impact: Recommendations are generated to a) decrease the frequency and/or portion size of high calorie foods; b) increase the frequency of low calorie foods; or c) increase the frequency, intensity, or time for exercise. These changes are based on the net calories saved. For example, if the pattern of eating hamburgers started in period four and it contributes significantly to the net calories then recommend reducing the number and/or size of hamburgers and offer.

Tie Changes to Particular Times and Places: Recommendations can be associated with the appropriate time of day (i.e., meal) or place (i.e., a restaurant). Recommendations can be offered repeatedly to establish new habits.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of recommending reestablishment of discontinued productive habits, the method comprising:
recording behaviors over time in pursuit of an identified goal;
measuring progress towards the identified goal over time;
identifying one or more periods of time where positive progress toward the identified goal resulted;
identifying one or more periods of time where negative progress toward the identified goal resulted;
identifying, by an electronic computer processor, differences in the behaviors between the periods of time where the positive progress resulted and the periods of time where the negative progress resulted; and
recommending behavior changes based on the identified differences of the behaviors.

2. The method of claim 1, further comprising:
wherein the behaviors are patterns of choices over time; and
wherein the patterns of choices are selected from a group consisting of food, activities, and products.

3. The method of claim 1, wherein the behaviors are recorded into a database.

4. The method of claim 1, wherein the periods of time is one week.

5. The method of claim 1, wherein the measurement of progress is performed by comparing a level of progress at the start of the period of time and a level of progress at the end of the period of a time.

6. The method of claim 1, further comprising:
wherein identifying the periods of time where negative progress toward the identified goal resulted includes identifying behaviors that contribute toward the identified goal;
wherein identifying one or more periods of time where negative progress toward the identified goal resulted includes identifying behaviors that detract from the identified goal; and
selecting behaviors in the one or more periods of positive progress, wherein the selected behaviors contribute the most progress per unit time.

7. The method of claim 6, wherein the selected behaviors in the one or more periods of positive progress are not found during the one or more periods of negative progress.

8. The method of claim 1, wherein the recommended behavior changes are presented to a user.

9. A system for recommending reestablishment of discontinued productive habits, the system comprising:
a system memory;
a computer processor coupled to the system memory;
a recording unit coupled to the computer processor, the recording unit to record behaviors over time in pursuit of an identified goal;
a measuring unit to measure progress towards the identified goal over time;
an identifying unit to identify one or more periods of time where positive progress toward the identified goal resulted,
an identifying unit to identify one or more periods of time where negative progress toward the identified goal resulted, and
differences in the behaviors between the periods of time where the positive progress resulted and the periods of time where the negative progress resulted; and
a recommending unit to recommend behavior changes based on the identified differences of the behaviors.

10. The system of claim 9, further comprising:
wherein the behaviors are patterns of choices over time; and
wherein the patterns of choices are selected from a group consisting of food, activities, and products.

11. The system of claim 9, wherein the behaviors are recorded into a database.

12. The system of claim 9, wherein the measurement of progress is performed by comparing a level of progress at the start of the period of time and a level of progress at the end of the period of a time.

13. The system of claim 9, further comprising:
wherein positive progress are behaviors that contribute toward the identified goal;
wherein negative progress are behaviors that detract from the identified goal; and
selecting behaviors in the one or more periods of positive progress, wherein the selected behaviors contribute the most progress per unit time.

14. The system of claim 13, wherein the computer processor is configured to select behaviors in the one or more periods of positive progress that are not found during the one or more periods of negative progress.

15. The system of claim 9, wherein the recommended behavior changes are presented to a user.

16. A computer program product for recommending reestablishment of discontinued productive habits, the computer program product comprising;
a computer readable storage medium having computer readable program code embodied therewith, the computer readable program code configured to:
record behaviors over time in pursuit of an identified goal;
measure progress towards the identified goal over time;
identify one or more periods of time where positive progress toward the identified goal resulted;
identify one or more periods of time where negative progress toward the identified goal resulted;
identify, by an electronic computer processor, differences in the behaviors between the periods of time where the positive progress resulted and the periods of time where the negative progress resulted; and
recommend behavior changes based on the identified differences of the behaviors.

17. The computer program product of claim 16, further comprising:
wherein the behaviors are patterns of choices over time; and
wherein the patterns of choices are selected from a group consisting of food, activities, and products.

18. The computer program product of claim 16, wherein the behaviors are recorded into a database.

19. The computer program product of claim 16, wherein the measurement of progress is performed by comparing a level of progress at the start of the period of time and a level of progress at the end of the period of a time.

20. The computer program product of claim 16, further comprising:
wherein positive progress are behaviors that contribute toward the identified goal;
wherein negative progress are behaviors that detract from the identified goal; and
selecting behaviors in the one or more periods of positive progress, wherein the selected behaviors contribute the most progress per unit time.
